(19) United States
(12) Patent Application Publication
(10) Pub. No.: US 2026/0048507 A1
(43) Pub. Date: Feb. 19, 2026

(54) MOTION PLANNING AND/OR COLLISION DETERMINATION USING CONTINUOUS ENVIRONMENT MODEL

(71) Applicant: The Regents of the University of Michigan, Ann Arbor, MI (US)

(72) Inventors: Ramanarayan VASUDEVAN, Ann Arbor, MI (US); Katerine Anne SKINNER, Ann Arbor, MI (US); Sean RICE, Ann Arbor, MI (US); Parker EWEN, Ann Arbor, MI (US); Adam LI, Ann Arbor, MI (US); Rahul SWAYAMPAKULA, Ann Arbor, MI (US); Challen ADU, Ann Arbor, MI (US); Seth ISAACSON, Ann Arbor, MI (US); Jonathan MICHAUX, Ann Arbor, MI (US)

(21) Appl. No.: 19/302,978

(22) Filed: Aug. 18, 2025

Related U.S. Application Data
(60) Provisional application No. 63/683,996, filed on Aug. 16, 2024.

(51) Int. Cl. B25J 9/16; G06T 15/50

(52) U.S. Cl. CPC B25J 9/1666; B25J 9/1671; B25J 9/1676; G06T 15/506

(57) ABSTRACT

A system and method for estimating a collision probability between a robot and a radiance field within a three-dimensional environment includes: determining forward occupancy information indicating potential over-approximating volumes that are able to be occupied by a robot disposed at a starting position; modeling an environment of the robot using a radiance field; and computing a probability of collision between the robot and an obstacle within the environment based on the forward occupancy information and the radiance field. The estimation method is useful for robotic trajectory determination that involves discretizing a trajectory of the robot into a sequence of trajectory segments over time subintervals; computing an upper-bound for a probability of collision between the robot and a radiance field at each of the time subintervals using a Gaussian Splatting model that normalizes 3D Gaussians within the radiance field; and performing real-time trajectory adjustments based on the computed collision probability upper-bounds.

### TECHNICAL FIELD

This disclosure relates to determining collision motion planning for a robot or other automatically-moveable component as well as determining collision information using a continuous environmental model, such as radiance field models.

### BACKGROUND

For a robot to safely navigate its environment, it must have a strong understanding of the scene geometry, including both a detailed model of the scene and a way to rigorously reason over collisions within the environment. To generate safe motion plans, many methods model the robot or the environment with simple geometric primitives, such as spheres, ellipsoids, capsules, or convex polygons, and perform collision-checking along a given trajectory at discrete time instances. This is common for state-of-the-art trajectory optimization-based approaches such as CHOMP [M. Zucker, N. Ratliff, A. D. Dragan, et al., “Chomp: Covariant hamiltonian optimization for motion planning,” The International Journal of Robotics Research, vol. 32, no. 9-10, pp. 1164-1193, 2013.], TrajOpt [J. Schulman, Y. Duan, J. Ho, et al., “Motion planning with sequential convex optimization and convex collision checking,” The International Journal of Robotics Research, vol. 33, no. 9, pp. 1251-1270, 2014.], and MPOT [A. T. Le, G. Chalvatzaki, A. Biess, and J. Peters, Accelerating motion planning via optimal transport, 2023.]. CHOMP represents the robot as a collection of discrete spheres and maintains a safety margin with the environment by utilizing a signed distance field. TrajOpt represents the robot and obstacles as the support mapping of convex shapes. Then, the distance and penetration depth between two convex shapes are computed by the Gilbert-Johnson-Keerthi [E. Gilbert, D. Johnson, and S. Keerthi, “A fast procedure for computing the distance between complex objects in three-dimensional space,” IEEE Journal on Robotics and Automation, vol. 4, no. 2, pp. 193-203, 1988.] and Expanding Polytope Algorithms [G. Bergen, “Proximity queries and penetration depth computation on 3d game objects,” January 2001.], respectively. MPOT represents the robot geometry and obstacles as spheres, and implements a collision cost using an occupancy map. Although these approaches have been demonstrated to solve challenging motion planning tasks in real-time, the resulting trajectories cannot be considered safe as collision avoidance is only enforced as a soft penalty in the cost function.

Reachability-based Trajectory Design (RTD) [S. Kousik, S. Vaskov, M. Johnson-Roberson, and R. Vasudevan, “Safe trajectory synthesis for autonomous driving in unforeseen environments,” in ASME 2017 Dynamic Systems and Control Conference, American Society of Mechanical Engineers Digital Collection, 2017.] is a recent approach to real-time motion planning that generates provably safe trajectories in a receding-horizon fashion. At runtime, RTD uses (polynomial) zonotopes [N. Kochdumper and M. Althoff, “Sparse polynomial zonotopes: A novel set representation for reachability analysis,” IEEE Transactions on Automatic Control, vol. 66, no. 9, pp. 4043-4058, 2020.] to construct reachable sets that over-approximate all possible robot positions corresponding to a pre-specified continuum of parameterized trajectories. RTD then solves a nonlinear optimization problem to select a feasible trajectory such that the swept volume corresponding to that motion is guaranteed to be collision-free. If a feasible trajectory is not found, RTD executes a braking maneuver that brings the robot safely to a stop. Importantly, the reachable sets are constructed such that obstacle-avoidance constraints are satisfied in continuous-time. However, while extensions of RTD have demonstrated real-time, certifiably safe motion planning for robotic arms [P. Holmes, S. Kousik, B. Zhang, et al., “Reachable Sets for Safe, Real-Time Manipulator Trajectory Design,” in Proceedings of Robotics: Science and Systems, Corvalis, Oregon, USA, July 2020.], [J. Michaux, P. Holmes, B. Zhang, et al., Can't touch this: Real-time, safe motion planning and control for manipulators under uncertainty, 2023.], [Z. Brei, J. Michaux, B. Zhang, P. Holmes, and R. Vasudevan, “Serving time: Real-time, safe motion planning and control for manipulation of unsecured objects,” IEEE Robotics and Automation Letters, vol. 9, no. 3, pp. 2383-2390, 2024.] with seven degrees of freedom, RTD's reachable sets tend to be overly conservative as demonstrated below.

Radiance field methods have recently arisen as a powerful method to build detailed models of the scene. These models generally use either Neural Networks (in the case of neural radiance fields or NeRFs) or a Gaussian basis set (in the case of Gaussian Splatting) to learn the parameters of the rendering equation, which is a fundamental model of image formation. In the past several years, these radiance methods have marked a paradigm shift in computer vision, with wide-ranging impacts in scene reconstruction, novel view synthesis, 3D tracking, and more.

Recent works have made strides toward achieving real-time motion planning in radiance fields. These systems demonstrate the promising benefits of equipping robots with tools to reason over radiance models. The greatest strength of radiance models is that they are continuous representations of the environment. This differs from conventional map representations in robotics, such as point clouds and occupancy grids, which discretize the environment. However, most existing motion planners for radiance fields either check for collisions at only a limited number of points on the robot body [M. Adamkiewicz, T. Chen, A. Caccavale, et al., Vision-only robot navigation in a neural radiance world, 2022.] or discretize the map before planning [T. Chen, P. Culbertson, and M. Schwager, Catnips: Collision avoidance through neural implicit probabilistic scenes, 2023.]. Hence, while the map representations are continuous, the planners built atop them enforce discretization. Other planners operate on a latent space that is supervised by the rendering equation. This avoids discretization but makes it challenging to reason rigorously about collisions [D. Driess, I. Schubert, P. Florence, Y. Li, and M. Toussaint, “Reinforcement learning with neural radiance fields,” in Advances in Neural Information Processing Systems (NeurIPS), 2022.]. Finally, a recent work builds a motion planner that directly avoids collisions with the confidence ellipsoids of 3D Gaussian functions [T. Chen, O. Shorinwa, W. Zeng, J. Bruno, P. Dames, and M. Schwager, Splat-nav: Safe real-time robot navigation in gaussian splatting maps, 2024.]. However, this method ignores the rendering density parameters of each Gaussian and is not differentiable, meaning it cannot easily be integrated into a trajectory optimizer.

It remains an open challenge to demonstrate that these radiance field methods (and other such continuous models) are directly useful for robotic navigation.

### SUMMARY

In accordance with an aspect of the invention, there is provided a method of estimating a collision probability between a robot and a radiance field within a three-dimensional environment. The method comprises: determining forward occupancy information indicating potential over-approximating volumes that are able to be occupied by a robot disposed at a starting position; modeling an environment of the robot using a radiance field; and computing a probability of collision between the robot and an obstacle within the environment based on the forward occupancy information and the radiance field.

In various embodiments, the estimation method may include one or more of the following features, either alone or in any technically feasible combination.
the probability of collision between the robot and an obstacle within the environment is determined using Gaussian Splatting.
the estimation method further comprises a step of normalizing three-dimensional (3D) Gaussians in a Gaussian splatting model to ensure the correctness of the collision probabilities.
the step of computing the probability of collision includes using the Gaussian Splatting by applying integration of normalized gaussian functions in a normalized gaussian splat for an efficient computation of a collision bound.
the modeling step includes deriving a mathematical model that represents the radiance field as a continuous function over the environment, and wherein the radiance field is composed of a plurality of radiance elements contributing to the probability of collision.
the forward occupancy information is spherical forward occupancy information modeled through representing one or more joints of the robot as spheres.
the forward occupancy information indicates an over-approximated robot occupancy volume including a link volume extending between a first joint and a second joint.
the link volume is over-approximated using a tapered capsule formed by a convex hull of a first sphere located at the first joint and a second sphere located at the second joint.
the radiance field models the environment by mapping points and viewing directions to volume density, and wherein color is ignored as a part of the radiance field.
the forward occupancy information is determined using polynomial zonotopes to overapproximate position and velocity trajectories of the robot over continuous time intervals.
the step of determining forward occupancy information includes constructing a Spherical Forward Occupancy using a collection of three-dimensional spheres to overapproximate the volume occupied by the robot's arm in the workspace.
the step of determining the probability of collision utilizes a transmittance function to compute the likelihood that a particle travels along a ray without collision, based on a density function computed from the radiance field.
the step of computing the probability of collision between the robot and an obstacle represented within the radiance field involves computing an upper bound on the probability of collision using Markov's inequality.
the computed probability of collision is used for trajectory optimization whereby a receding-horizon motion planning algorithm is used to select a feasible trajectory which does not exceed a user-specified collision probability threshold.
the trajectory optimization includes real-time adjustments to a trajectory of the robot based on the forward occupancy information, and wherein the forward occupancy information is overapproximated by the Spherical Forward Occupancy which is computed using polynomial zonotopes.
the radiance field is trained using simulated color and depth data to accurately represent the environment for collision probability estimation.

In accordance with another aspect of the invention, there is provided a method for real-time trajectory determination in a robotic system, comprising: discretizing a trajectory of a robot into a sequence of trajectory segments over time subintervals; computing an upper-bound for a probability of collision between the robot and a radiance field at each of the time subintervals using a Gaussian Splatting model that normalizes 3D Gaussians within the radiance field; and performing real-time adjustments to the trajectory based on the computed upper-bounds for collision probability.

In various embodiments, the trajectory determination method may include one or more of the following features, either alone or in any technically feasible combination.
the computing step includes the use of a probabilistic model to account for uncertainties in the position and shape of the radiance field.
the trajectory determination method further comprising aggregating the computed upper-bounds to estimate an overall collision probability for the entire trajectory.
the aggregating step uses a risk assessment algorithm to prioritize trajectory segments based on their associated collision probabilities.
the Gaussian Splatting model is derived directly from the rendering equation.
the robot includes a manipulator operating within a dynamic environment with unpredictable changes.
the real-time adjustments to the trajectory include avoidance maneuvers to minimize the collision probability.
the real-time adjustments are computed using a receding-horizon motion planning algorithm.

### BRIEF DESCRIPTION OF THE DRAWINGS

One or more illustrative embodiments will hereinafter be described in conjunction with the following figures, wherein like numerals denote like elements, and wherein:

FIG. 1 is diagram of a robotic collision avoidance system that is used for motion planning for a robot within a three-dimensional environment;

FIG. 2 diagrammatically depicts the robot within the three-dimensional environment which contains obstacles to the robots trajectory;

FIG. 3 is a diagrammatic view as in FIG. 2, but showing over-approximated joints and volumes of the robot;

FIG. 4 is a flow chart showing an embodiment of a method for estimating a collision probability between a robot and a radiance field within the three-dimensional environment; and

FIG. 5 is a flow chart showing an embodiment of a method for real-time trajectory determination in a robotic system such as shown in FIG. 1.

### DETAILED DESCRIPTION

The system and method described herein enables motion planning, such as for robot navigation within an environment, particularly through bounding a probability of collision between a three-dimensional (3D) body and a radiance field. Embodiments of the system and method integrate forward occupancy modeling and radiance field methods to compute collision probabilities, enhancing the safety and reliability of autonomous movement within real-time, dynamic, and/or complex three-dimensional environments.

As discussed above, current radiance field-based motion planning methods are non-differentiable, and are not adaptable in real-time environments. More particularly, the system and method are aimed at, at least in embodiments, addressing the challenges of motion planning within radiance fields, which are detailed models of the environment created using methods like Neural Radiance Fields and Gaussian Splatting, as discussed above. Traditional methods have struggled to reason rigorously over collisions within these models and to perform inference or probability computations fast enough for real-time planning. The proposed technology overcomes these issues by introducing a risk-aware trajectory planner that operates within a Gaussian Splatting model. It rigorously computes the probability of collision with the environment and ensures that the computation can be performed efficiently enough for real-time application.

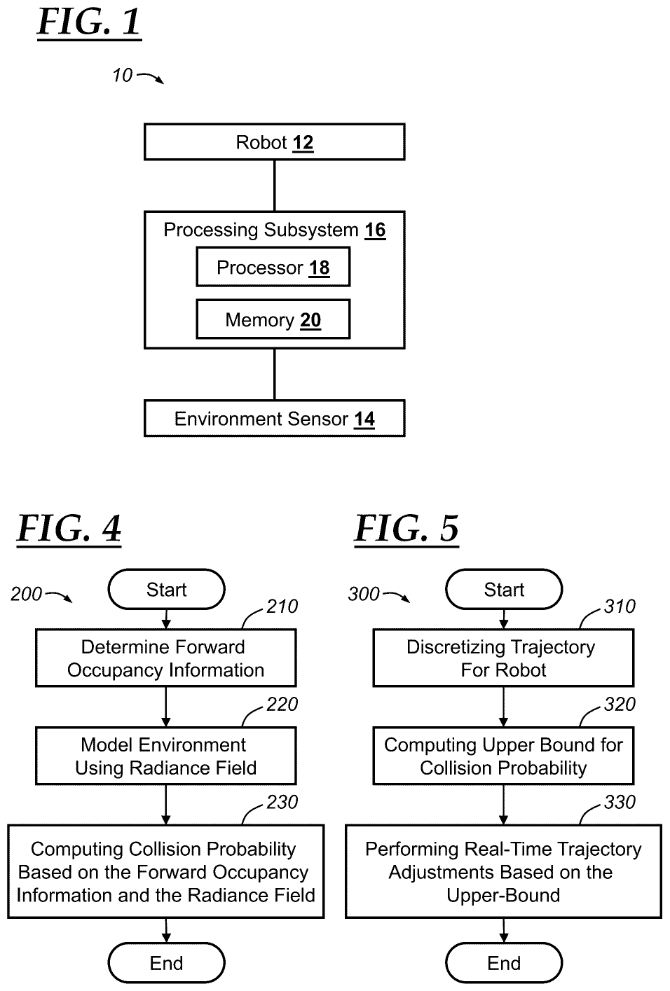

With reference to FIG. 1, there is shown a robotic collision avoidance system 10 that is used for motion planning for a robot 12 within an environment E. In the exemplary embodiment discussed below, the robotic collision avoidance system 10 is used for determining collision probability information and then determining a trajectory for the robot, such as for a robotic arm of the robot, based on the collision probability information; in this sense, the robotic collision avoidance system 10 is a system that uses collision probability information for motion planning with an objective of avoiding obstacles within the robot's environment E. The system 10 is comprised of hardware, namely at least one processor and memory, as well as software or other computer code or instructions (referred to herein as “computer instructions”) that is executed by the hardware. Accordingly, computer instructions are stored in the memory of the system 10, and these computer instructions are made available to the at least one processor of the system 10, which then executes the computer instructions so as to perform the method discussed below.

The robotic collision avoidance system 10 includes a robot 12, an environment sensor 14, and a processing subsystem 16 having at least one processor 18 and memory 20. Although the processing subsystem 16 is shown as being separate from the robot 12, in other embodiments, the processing subsystem 16 is incorporated into the robot 12, and may be referred to as an onboard controller or processing subsystem.

The environment sensor 14 is a sensor that is used for obtaining information used for modeling the environment using a radiance field. In one embodiment, the environment sensor 14 is a stereoscopic visible light camera and, in another embodiment, the environment sensor 14 is a lidar device. And, of course, in at least some embodiments, multiple different environment sensors may be used and their respective sensor data may be fused, for example, in order to convey spatial information used as a part of the radiance field modeling discussed herein.

The processing subsystem 16 is used for performing the method discussed below. The processing subsystem 16 may include one or more local and/or remote (e.g., cloud-based) computers or controllers, according to embodiments. The at least one processor 18 refers to one or more electronic processors. Any one or more of these processors or other processors discussed herein may be implemented as any suitable electronic hardware that is capable of processing computer instructions and may be selected based on the application in which it is to be used. Examples of types of processors that may be used include central processing units (CPUs), graphics processing units (GPUs), field-programmable gate arrays (FPGAs), application specific integrated circuits (ASICs), microprocessors, microcontrollers, etc.

The memory 20 refers to one or more non-transitory, computer-readable memory devices (or memories), and any of these memories or other memory discussed herein may be implemented as any suitable type of memory that is capable of storing data or information in a non-volatile manner and in an electronic form so that the stored data or information is consumable by the processor. The memory may be any a variety of different electronic memory types and may be selected based on the application in which it is to be used. Examples of types of memory that may be used include magnetic or optical disc drives, ROM (read-only memory), solid-state drives (SSDs) (including other solid-state storage such as solid-state hybrid drives (SSHDs)), other types of flash memory, hard disk drives (HDDs), non-volatile random access memory (NVRAM), etc. It will be appreciated that the computers may include other memory, such as volatile RAM that is used by the processor, and/or multiple processors.

The memory serves as a local data store for storing the computer instructions, but may also be used for storing various data obtained or generated by the robotic collision avoidance system 10. A “data store” or “electronic data store” refers to any data storage platform, such as cloud storage services like Amazon S3™ or Google Drive™, relational databases like MySQL™ or PostgreSQL™, and NoSQL databases like MongoDB™ or Cassandra™, that is designed for storing data in a manner accessible by electronic processing systems. This includes any repository that allows for the organization, management, and retrieval of data through digital means, enabling efficient data handling, analysis, and processing by computers and other electronic devices. This electronic data store could take the form of a cloud database, such as Amazon's DynamoDB™, which offers seamless scalability and performance. Alternatively, for structured data and frequent queries, a relational database like MySQL™ or PostgreSQL™ could be employed. If the data is unstructured or semi-structured and comes in large volumes, NoSQL databases such as MongoDB™ or Apache Cassandra™ might be more suitable. For data that is time-series in nature, time-series databases like InfluxDB™ or TimescaleDB™ could provide efficient storage and query capabilities. For large-scale data analysis, data warehousing solutions such as Google BigQuery™, Amazon Redshift™, or Snowflake™ can be used. In cases where fast data access is paramount, in-memory databases like Redis™ or Memcached™ could be employed. Lastly, for storing large volumes of raw data, distributed file systems like Hadoop HDFS™ or cloud-based solutions like Amazon S3™ could be used. The choice of data store would ultimately depend on the specific requirements of the system handling the data. The robotic collision avoidance system 10 may be implemented using a variety of different processing techniques, including use of cloud computing frameworks and services, such as those offering real-time data streaming and processing, such as Amazon Web Services (AWS) Kinesis™, for example. In other embodiments, local computers or processing machines may be used for the hardware.

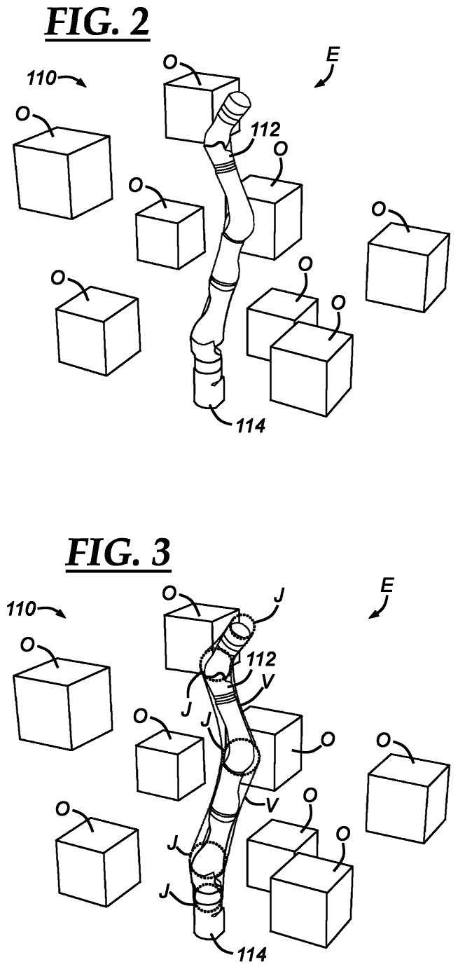

With reference to FIGS. 2-3, there is shown an embodiment in which a robot 100 is determining collision probabilities within its environment E. The robot 100 is an embodiment of the robot 12 of FIG. 1, and the discussion of the robot 12 is hereby incorporated and attributed to the robot 100.

The robot 100 has a robot arm 102 and a base 104, which may be fixed to a surface or other part of the robot 100. The robot 100 is shown as being in an environment E with obstacles O, shown as cubes. FIG. 2 shows the robot 100 while FIG. 3 shows the robot 100 along with over-approximated regions or volumes V extending in a tapered manner between joints J of the robot arm 102, as indicated by the dotted lines in FIG. 3. The volume V of each joint J is over-approximated by a tapered capsule formed by the convex hull as shown in FIG. 3 interposed between two joints J.

Sets and subspaces are typeset using capital letters. Subscripts are primarily used as an index or to describe a particular coordinate of a vector. Let [symbol] and [symbol] denote the spaces of real numbers and natural numbers, respectively. The Minkowski sum between two sets [symbol] and [symbol] ′ is [symbol] ⊕ [symbol] ′={a+a′|a∈ [symbol] , a′∈ [symbol] ′}. Given a set [symbol] , its power set is denoted as P( [symbol] ). Given vectors α, β∈ [symbol] ⁿ, let [α]ᵢ denote the i-th element of α, let diag(α) denote the diagonal matrix with α on the diagonal, and let int(α, β) denote the n-dimensional box defined as {γ∈ [symbol] ⁿ|[α]ᵢ≤[γ]ᵢ≤[β]ᵢ, ∀i=1, . . . , n}. Given α∈Rⁿ and ε>0, let Bₚ(α, ε) denote the n-dimensional closed ball with center α and radius ε under the L^{p} norm. Given a set Ω⊂ [symbol] ⁿ^{_{d}}, let ∂Ω⊂ [symbol] ⁿ^{_{d}} be its boundary, Ω^{c}⊂ⁿ^{_{d}} denote its complement, and co(Ω) denote its convex hull, which is the smallest convex set containing Ω.

Presented below is a brief overview of the definitions and operations on polynomial zonotopes (PZs) that are used herein. A thorough introduction to polynomial zonotopes is available in N. Kochdumper and M. Althoff, “Sparse polynomial zonotopes: A novel set representation for reachability analysis,” IEEE Transactions on Automatic Control, vol. 66, no. 9, pp. 4043-4058, 2020.

Given generators gᵢ∈ [symbol] ^{n×n}^{_{g}} and exponents αᵢ∈Nⁿ^{_{g}} for i∈{0, . . . , n_{g}}, a polynomial zonotope is a set:

$$P = \{ z ∈ {ℝ}^{n} \vert z = {\sum }_{i = 0}^{{n}_{g}} {g}_{i} {x}^{{α}_{i}} , x ∈ {[ - 1 , 1 ]}^{{n}_{g}} \} \qquad Equation ( 1 )$$

For each i∈{0, . . . , n_{g}}, x^{α}^{ᵢ} is referred to as a monomial and the exponent associated with the zeroth generator is set to be zero, i.e., α₀=[0, 0, . . . , 0]. x∈[−1,1]ⁿ^{_{g}} is referred to as indeterminates, and g₀ as the center.

Bold symbols are used to denote polynomial zonotopes. There exists a variety of operations that can be performed on polynomial zonotopes including Mikowski sums, multiplying two or more polynomial zonotopes, generating upper and lower bounds, converting the polynomial zonotope to an interval, and evaluating polynomial zonotopes with analytic functions.

Below is a description of an embodiment in which motion planning is determined for a robot within an environment.

The goal of the present embodiment, referred to as “Splanning”, is to generate collision-free motion plans in cluttered environments. Here, an assumption about the environment and its obstacles:
Assumption 1. The robot and obstacles are all located in fixed inertial world reference frame denoted W⊂ [symbol] ³. The origin of W is known, and each obstacle's pose is fixed relative to W with respect to time. At any time, the set of obstacles in the environment is represented by a radiance field, as defined below.
   Note that, for simplicity, the simulated environments discussed below contain obstacles that are represented as axis-aligned cubes, such as shown in FIGS. 2 and 3. In the real-world experiments, the environment includes objects with arbitrary geometries.

### Robot Model.

For modeling a robot, such as the robot 100, in the present embodiment, a serial robotic manipulator with n_{q}∈ [symbol] degrees of freedom and with configuration space denoted Q is considered. Here, in the present embodiment, the kinematics of the robotic arm as well as the arm occupancy (referring to the volume occupied by the arm in the environment) are described.

In regard to arm kinematics, given a compact time interval T⊂ [symbol] , a trajectory is defined for the configuration as q: T→Q⊂ [symbol] ⁿ^{_{q}} and a trajectory for the velocity as \dot{q}: T→ [symbol] ⁿ^{_{q}}. The following assumptions about the structure of the robot model are used in the present embodiment:
Assumption 2. The robot operates in a three-dimensional workspace, denoted Wₛ⊂ [symbol] ³, such that Wₛ⊂W. There exists a reference frame called the base frame, denoted the 0^{th} frame, that indicates the origin of the robot's kinematic chain. Without loss of generality, assume the robot's base frame coincides with the origin of the world frame. For a mobile robot, this assumption can be satisfied via a suitable coordinate transformation. The robot is fully actuated and composed of only revolute joints, where the j^{th} joint actuates the robot's j^{th} link. The robot's j^{th} joint has position and velocity limits given by

$${q}_{j} ( t ) ∈ [ {q}_{j , lim}^{-} , {q}_{j , lim}^{+} ] and {\dot{q}}_{j} ( t ) ∈ [ {\dot{q}}_{j , lim}^{-} , {\dot{q}}_{j , lim}^{+} ]$$

for all t∈T, respectively. The robot's input is given by u: T→ [symbol] ⁿ^{_{q}}.
It is further assumed, at least in the present embodiment, that the robot's j^{th} reference frame {\hat{x}ⱼ,ŷⱼ,\hat{z}ⱼ} is attached to the robot's j^{th} revolute joint, and that \hat{z}ⱼ=[0,0,1]^{T} points in the direction of the j^{th} joint's axis of rotation. Then, for a time-dependent configuration, q(t), FKⱼ: Q→ [symbol] ^{4×4} maps the robot's configuration to the pose of the j^{th} joint in the world frame:

$$F {K}_{j} ( q ( t ) ) = [ \begin{matrix}{R}_{j} ( q ( t ) ) & {p}_{j} ( q ( t ) ) \\ 0 & 1\end{matrix} ] \qquad Equation ( 2 )$$

$$where$$

$${p}_{j} ( q ( t ) ) = {\sum }_{l = 1}^{j} {R}_{l} ( q ( t ) ) {p}_{l}^{l - 1} \qquad Equation ( 3 )$$

$$and$$

$${R}_{j} ( q ( t ) ) : = {R}_{j}^{0} ( q ( t ) ) = {\prod }_{l = 1}^{j} {R}_{l}^{l - 1} ( {q}_{l} ( t ) ) \qquad Equation ( 4 )$$

are the position and orientation of frame j with respect to world frame W, respectively.

In the present embodiment, for simplicity, Assumption 2 only specifies revolute joints to simplify the description of the forward kinematics. However, those skilled in the art will appreciate, especially in light of the present discussion herein, that the methods described herein apply and are extended readily to other joint types. Any uncertainty in the robot's dynamics is also ignored and, instead, it is assumed that one could apply an inverse dynamics controller [M. Spong, S. Hutchinson, and M. Vidyasagar, “Robot modeling and control,” 2005.] to track any trajectory of the robot perfectly. As a result, this embodiment focuses exclusively on modeling the kinematic behavior of the robotic arm.

With regard to the arm occupancy, the arm's forward kinematics (Equation (2)) is used to define the forward occupancy which is the volume occupied by the arm in the workspace Wₛ. Let Lⱼ⊂Wₛ⊂ [symbol] ³ denote the volume occupied by the robot's j^{th} link with respect to the j^{th} reference frame. Then, the forward occupancy of link j is the map FOⱼ: Q→ [symbol] (Wₛ) defined as

$${FO}_{j} ( q ( t ) ) = {p}_{j} ( q ( t ) ) ⊕ {R}_{j} ( q ( t ) ) {L}_{j} \qquad Equation ( 5 )$$

where pⱼ(q(t)) is the position of joint j, Rⱼ(q(t)) is the orientation of joint j, and Rⱼ(q(t))Lⱼ is the rotated volume of link j. The volume occupied by the entire arm in the workspace is then given by the function FO: Q→Wₛ that is defined as

$$FO ( q ( t ) ) = {{⋃}^{{n}_{q}}}_{j = 1} {FO}_{j} ( q ( t ) ) ⊂ {W}_{s} \qquad Equation ( 6 )$$

Note that the geometry of any of the robot's links may be arbitrarily complex. Therefore, an assumption that simplifies the construction of an over-approximation to the forward occupancy is introduced:
Assumption 3. Given a robot configuration q(t) and any j∈{1, . . . , n_{q}}, there exists a ball (or sphere) with center pⱼ(q(t)) and radius rⱼ that overapproximates the volume occupied by the j^{th} joint in Wₛ. It is further assumed that the link volume Lⱼ is a subset of the tapered capsule formed by the convex hull of the balls overapproximating the j^{th} and j+1^{th} joints.

Following Assumption 3, the ball Sⱼ(q(t)) over-approximating the volume occupied by the j^{th} joint is defined as:

$${S}_{j} ( q ( t ) ) = {B}_{2} ( {p}_{j} ( q ( t ) ) , {r}_{j} ) \qquad Equation ( 7 )$$

and the tapered capsule TCⱼ(q(t)) over-approximating the j^{th} link as:

$$T {C}_{j} ( q ( t ) ) = c o ( {S}_{j} ( q ( t ) ) ⋃ {S}_{j + 1} ( q ( t ) ) ) \qquad Equation ( 8 )$$

Then, the volumes occupied by the j^{th} link (Equation (5)) and the entire arm (Equation (6)) can be over-approximated by:

$${FO}_{j} ( q ( t ) ) ⊂ {TC}_{j} ( q ( t ) ) \qquad Equation ( 9 )$$

$$and$$

$$FO ( q ( t ) ) ⊂ {{⋃}^{{n}_{q}}}_{j = 1} {TC}_{j} ( q ( t ) ) ⊂ {W}_{s} \qquad Equation ( 10 )$$

respectively.

For convenience, the notation FO(q(T)) denotes the forward occupancy over an entire time interval T. FO(q(T)) is also called the “reachable set” of the robot. The arm is “collision-free” over the time interval T if FO(q(T))∩ [symbol] =Ø for all [symbol] ∈ [symbol] .

For trajectory design, in the present embodiment employing Gaussian splatting for motion planning of a robot, which is referred to as “Splanning,” safe trajectories are computed by solving an optimization program over parameterized trajectories at each planning iteration in a receding-horizon manner. Offline, a continuum of trajectories over a compact set K⊂ [symbol] ⁿ^{ₖ}, nₖ∈ [symbol] are pre-specified. Then, each trajectory, defined over a compact time interval T, is uniquely determined by a “trajectory parameter” k∈K. Note, that K is designed for safe manipulator motion planning, but K may also be designed for other tasks and robot morphologies [P. Holmes, S. Kousik, B. Zhang, et al., “Reachable Sets for Safe, Real-Time Manipulator Trajectory Design,” in Proceedings of Robotics: Science and Systems, Corvalis, Oregon, USA, July 2020; S. Kousik, S. Vaskov, F. Bu, M. Johnson-Roberson, and R. Vasudevan, “Bridging the gap between safety and real-time performance in receding-horizon trajectory design for mobile robots,” The International Journal of Robotics Research, vol. 39, no. 12, pp. 1419-1469, 2020; S. Kousik, P. Holmes, and R. Vasudevan, “Safe, aggressive quadrotor flight via reachability-based trajectory design,” in ASME 2019 Dynamic Systems and Control Conference, American Society of Mechanical Engineers Digital Collection, 2019; J. Liu, Y. Shao, L. Lymburner, et al., Refine: Reachability-based trajectory design using robust feedback linearization and zonotopes, 2022] as long as it satisfies the following properties:
Assumption 4 (Trajectory Parameters). For each k∈K, a parameterized trajectory is an analytic function q(⋅; k):T→Q that satisfies the following properties:
   I. The parameterized trajectory starts at a specified initial condition (q₀, \dot{q}₀), so that q(0; k)=q₀, and \dot{q}(0; k)=\dot{q}₀.
II. Each parameterized trajectory brakes to a stop such that \dot{q}(t_{f}; k)=0.

Here, Splanning performs real-time receding horizon planning by executing the desired trajectory computed at the previous planning iteration while constructing the next desired trajectory for the subsequent time interval. Therefore, the first property ensures each parameterized trajectory is generated online and begins from the appropriate future initial condition of the robot. The second property ensures that a braking maneuver is always available to bring the robot safely to a stop.

The following equations are used, at least in the present embodiment, for formulating the motion planning problem.

$${min}_{k ∈ K} cost ( k ) \qquad Equation ( 11 )$$

$${q}_{j} ( t ; k ) ∈ [ {q}_{j , lim}^{-} , {q}_{j , lim}^{+} ] ∀ t ∈ T , j ∈ {N}_{q} \qquad Equation ( 12 )$$

$${q}_{j} ( t ; k ) ∈ [ {\dot{q}}_{j , lim}^{-} , {\dot{q}}_{j , lim}^{+} ] ∀ t ∈ T , j ∈ {N}_{q} \qquad Equation ( 13 )$$

$${FO}_{j} ( q ( t ; k ) ) ⋂ 𝒪 = ∅ ∀ t ∈ T , j ∈ {N}_{q} \qquad Equation ( 14 )$$

Below, there is first a discussion on how to over-approximate the robot's desired position and velocity trajectories using polynomial zonotopes (Assumption 1), as well as using the over-approximated trajectories to construct an over-approximation of the forward occupancy in Equation (14) called the Spherical Forward Occupancy. There also is a brief overview of radiance fields in general, and Gaussian splatting more particularly, along with a description on how to compute the probability of collision between a ball in [symbol] ³ and a learned radiance field represented by the Gaussian splats. Further, there is a discussion on how to reformulate the constraints in (Opt) to the constraints in (Splanning-Opt).

With respect to parameterized trajectories, embodiments described herein using such techniques, risk-aware motion planning is enabled by constructing safety constraints that overapproximate the robot's position (Equation (12)), velocity (Equation (13)), and forward occupancy (Equation (14)) over continuous time intervals. Below is a discussion on how to overapproximate the parameterized trajectories introduced in Assumption 4.

Start by choosing a timestep Δt that divides the compact time horizon T⊂ [symbol] into

$${n}_{t} := \frac{T}{Δ t}$$

time subintervals (or future time intervals):

$${T}_{i} = \{ t ∈ T \vert t = \frac{( i - 1 ) + i}{2} Δ t + \frac{1}{2} Δ {tx}_{{t}_{i}} , {x}_{{t}_{i}} ∈ [ - 1 , 1 ] \} \qquad Equation ( 15 )$$

where each subinterval is indexed by the set Nₜ:={1, . . . , nₜ}. Note that because intervals are a special case of polynomial zonotopes [N. Kochdumper and M. Althoff, “Sparse polynomial zonotopes: A novel set representation for reachability analysis,” IEEE Transactions on Automatic Control, vol. 66, no. 9, pp. 4043-4058, 2020 (hereinafter “N. Kochdumper et al.”)], each Tᵢ is also a polynomial zonotope. The compact, nₖ-dimensional trajectory parameter set K⊂ [symbol] ⁿ^{ₖ} as a polynomial zonotope K. Then, the rules of polynomial zonotope arithmetic [N. Kochdumper et al.], [J. Michaux, P. Holmes, B. Zhang, et al., Can't touch this: Real-time, safe motion planning and control for manipulators under uncertainty, 2023 (hereinafter “J. Michaux et al.”)] allow one to overapproximate the desired position (Equation (12)) and velocity (Equation (13)) trajectories by plugging Tᵢ and K into the formulas for qⱼ(t; k) and \dot{q}ⱼ(t; k). This result is restated as a lemma whose proof can be found in [J. Michaux et al.].
Assumption 5 (Parameterized Trajectory PZs). The parameterized trajectory polynomial zonotopes qⱼ(Tᵢ; K) are over-approximative, i.e., for each j∈N_{q} and k∈Kⱼ,

$${q}_{j} ( t ; k ) ∈ \begin{matrix}{q}_{j} ( {T}_{i} ; K ) & ∀ t ∈ {T}_{i}\end{matrix} .$$

Similarly, one can define \dot{q}_{J}(Tᵢ; K) that are also over-approximative.

In regard to Spherical Forward Occupancy, below is a discussion on how to over-approximate the forward occupancy introduced above with a collection of three-dimensional balls or spheres. In general, the idea is that one can plug the polynomial zonotope trajectories (Equation (16)) into a polynomial zonotope version of the robot's forward kinematics (Equations (2)-(4)) to get an over-approximation of the position of each joint over the time interval Tᵢ. Each joint position can then be over-approximated by a three-dimensional ball and added to the nominal joint ball (Assum. 3) using the Minkowski sum operation. Then by Assumption 3, each link is contained in the tapered capsule TCⱼ(q(Tᵢ; k)) of two successive joint balls over the time interval Tᵢ. The following theorem, which originally appeared in [J. Michaux, A. Li, Q. Chen, C. Chen, B. Zhang, and R. Vasudevan, “Safe planning for articulated robots using reachability-based obstacle avoidance with spheres,” ArXiv, vol. abs/2402.08857, 2024] as Theorem 10, summarizes the results of applying these steps and proves that TCⱼ(q(Tᵢ; k)) can be over-approximated by a finite number of nₛ balls.
Assumption 6 (Spherical Forward Occupancy). Let nₛ∈ [symbol] be given. Then, for each m∈Nₛ={1, . . . , nₛ} there exists a closed ball with center c̅_{j,i,m}(k) and finite radius r̅_{j,i,m}(k) denoted

$${\overline{S}}_{j , i , m} ( q ( {T}_{i} ; k ) ) = {B}_{2} ( {\overline{c}}_{j , i , m} ( k ) , {\overline{r}}_{j , i , m} ( k ) ) \qquad Equation ( 17 )$$

$$such that$$

$$\begin{matrix}{FO}_{j} ( q ( {T}_{i} ; k ) ) ⊂ {TC}_{j} ( q ( {T}_{i} ; k ) ) ⊂ {{⋃}^{{n}_{s}}}_{m = 1} {\overline{S}}_{j , i , m} ( q ( {T}_{i} ; k ) ) \\ for each j ∈ {N}_{q} , k ∈ K , and t ∈ {T}_{i} .\end{matrix} \qquad Equation ( 18 )$$

For convenience, the union of balls on the right-hand side of Equation (18) is referred to as the “Spherical Forward Occupancy” for the j^{th} link at the i^{th} timestep.

With respect to 3D scene representation, and, in particular, volume rendering, a radiance field function is defined and discussed below. A radiance field is a 5-dimensional function [symbol] : (x, d) [symbol] (r, g, b, σ) that maps a point x∈ [symbol] ³ and viewing direction d∈ [symbol] ² to r, g, b colors and a volume density σ. Here, in the present embodiment, color is neglected as it does not impact the probability of collision. Further, the density σ does not depend on the view direction, and thus, a radiance model may be re-defined as estimating a density function σ: [symbol] ³→ [symbol] .

A ray ϕ: [symbol] → [symbol] ³ is defined by ϕ(t)=tv, where v∈ [symbol] ² is a unit direction vector. The density function σ is then used to compute the probability that a particle travels along ϕ(t) from t=a to t=b without collision using the transmittance function

$${𝒯}_{a}^{b}$$

[A. Tagliasacchi and B. Mildenhall, Volume rendering digest (for nerf), 2022]:

$${𝒯}_{a}^{b} [ ϕ ] = exp ( - {\int }_{a}^{b} σ ( ϕ ( t ) ) ‖ \frac{dr}{dt} ‖ dt ) \qquad Equation ( 19 )$$

$${𝒯}_{a}^{b} [ ϕ ] = exp ( - {\int }_{a}^{b} σ ( ϕ ( t ) ) dt ) \qquad Equation ( 20 )$$

The second equivalence results from

$$‖ \frac{d ϕ}{dt} ‖ = ‖ v ‖ = 1.$$

Equivalently,

$${C}_{a}^{b} [ ϕ ]$$

may be defined as the random event describing a particle colliding while traveling along ϕ from a to b, where

$$P ( {C}_{a}^{b} [ ϕ ] )$$

denotes the probability that a collision occurs. Then,

$$P ( {C}_{a}^{b} [ ϕ ] ) = 1 - {𝒯}_{a}^{b} [ ϕ ] \qquad Equation ( 21 )$$

Now, for Gaussian Splatting, three-dimensional Gaussians are used as basis functions to represent the density function σ. In particular, for a point x∈ [symbol] ³, the density is estimated by:

$$σ ( x ) = {{\sum }^{{n}_{G}}}_{n = 1} {Gw}_{n} {G}_{n} ( x ) \qquad Equation ( 22 )$$

where wₙ∈ [symbol] ⁺ is a weight parameter, n_{G} is the number of Gaussians, and Gₙ(x) is the un-normalized Gaussian density with mean μₙ∈ [symbol] ³ and covariance matrix Σₙ: ∈ [symbol] ^{3×3}.

$$\begin{matrix}{G}_{n} ( x ) = exp ( - \frac{1}{2} {‖ x - {μ}_{n} ‖}_{{\sum }_{n}^{- 1}}^{2} ) \\ = exp ( - \frac{1}{2} {( x - {μ}_{n} )}^{T} {\sum }_{n}^{- 1} ( x - {μ}_{n} ) )\end{matrix} \qquad Equation ( 23 )$$

Thus, in a Gaussian Splatting context, the collision probability of a ray ϕ with a single Gaussian Gₙ and weight wₙ is

$$\begin{matrix}P ( {C}_{a}^{b} [ ϕ ] ) = 1 - {𝒯}_{a}^{b} [ ϕ ] \\ = 1 - exp ( - {\int }_{a}^{b} σ ( ϕ ( t ) ) dt ) \\ = 1 - exp ( - {\int }_{a}^{b} {w}_{n} {G}_{n} ( ϕ ( t ) ) dt ) \\ = 1 - exp [ {w}_{n} {\int }_{a}^{b} exp ( - \frac{1}{2} {‖ ϕ ( t ) {μ}_{n} ‖}_{{\sum }_{n}^{- 1}}^{2} ) dt ]\end{matrix} \qquad Equation ( 24 )$$

With respect to probability of collision, Splanning enforces safety by ensuring the probability of collision between the Spherical Forward Occupancy and the scene is below a given or predetermined risk threshold. Here, in this embodiment, a method for bounding the probability of collision between a ball in [symbol] ³ and a scene represented as a radiance field is derived.

Suppose S=B₂(0, ρ) is a ball of radius p and centered at the origin. It may be assumed, without loss of generality, that S is placed at the origin because one can apply a frame transformation to an arbitrary ball in [symbol] ³ to shift its center to the origin. Intuitively, collisions between the scene and the ball S are defined as follows. Suppose a random ray ϕ is cast from the ball's center to its surface. The probability that the randomly cast ray is in collision with the environment is computed. To formalize this intuition, let ϕ∈ [symbol] ² represent a (unit) direction vector that is chosen uniformly at random from [symbol] ². The probability that the randomly selected ray experiences a collision with some risk threshold α is sought. That is, it is said a ray is in collision if

$${P}_{1} ( {C}_{0}^{ρ} [ ϕ ] ) \geq α .$$

Then, the probability that a ball is in collision with the scene is defined as:

$${P}_{3} ( C ( S ) ) = {P}_{2} ( {P}_{1} ( {C}_{0}^{ρ} [ ϕ ] ) \geq α ) \qquad Equation ( 25 )$$

Above, the inner inequality defines the condition to consider a given ray r as in collision with the scene. The outer probability then evaluates the likelihood that a random ray r from the center to the surface of the sphere is in collision. To formulate a risk-aware planner, the following constraint is enforced:

$${P}_{3} ( C ( S ) ) < β \qquad Equation ( 26 )$$

for a given risk threshold β∈(0,1], where P₃(C(S)) is defined as in Equation (25).

With respect to computing the collision bound, the constraint in Equation (26) is enforced by an upper bound that is provided on P(C(S)).
Assumption 7 Consider a ball S=B₂(0, ρ) of radius ρ and which is, without loss of generality, assumed to be at the origin of the coordinate system. Let α denote the risk threshold defined in Equation (25) for the probability of collision between a ray and the environment. Then, the probability that the ball S is in collision with the environment is bounded above by

$${P}_{3} ( C ( S ) ) \leq \frac{1}{α} [ 1 - exp ( - \frac{1}{4 π} {\int }_{𝕊} σ ( x ) dx ) ] \qquad Equation ( 27 )$$

[symbol]

Proof is had by the following, beginning with considering the definition of P₁(C( [symbol] )) from Equation (26). From Markov's inequality, one has that

$${P}_{2} ( {P}_{1} ( {C}_{0}^{ρ} [ ϕ ] ) \geq α ) \leq \frac{{𝔼}_{P ( ϕ )} ( {P}_{1} ( {C}_{0}^{ρ} [ ϕ ] ) )}{α} \qquad Equation ( 28 )$$

where the expectation is taken over the uniformly distributed space of possible rays. The remainder of the proof focuses on computing this expectation, beginning with its definition.

$$\begin{matrix}{𝔼}_{P ( ϕ )} ( {P}_{1} ( {C}_{0}^{ρ} [ ϕ ] ) ) = {\int }_{{𝕊}^{2}} {P}_{1} ( {C}_{0}^{ρ} [ ϕ ] ) dP ( ϕ ) \\ = {\int }_{{𝕊}^{2}} ( 1 - {T}_{0}^{ρ} [ ϕ ] ) dP ( ϕ ) \\ = 1 - {\int }_{{𝕊}^{2}} exp ( - {\int }_{0}^{ρ} σ ( ϕ ( t ) dt ) ) dP ( ϕ )\end{matrix} \qquad Equation ( 29 )$$

The final equality results from Equation (19). It then follows from Jensen's inequality that

$$\begin{matrix}{𝔼}_{P ( ϕ )} ( {P}_{1} ( {C}_{0}^{ρ} [ ϕ ] ) ) \leq 1 - exp ( - {\int }_{{𝕊}^{2}} {\int }_{0}^{ρ} σ ( ϕ ( t ) ) dt dP ( ϕ ) ) \\ = 1 - exp ( - P ( ϕ ) {\int }_{{𝕊}^{2}} {\int }_{0}^{ρ} σ ( ϕ ( t ) ) dt d ϕ )\end{matrix} \qquad Equation ( 30 )$$

The second equality results from the fact that ϕ is uniformly distributed on [symbol] ², and thus P(ϕ) does not depend on the choice of ϕ.

ϕ(t) may now be re-parameterized in spherical coordinates, such that

$$\hat{ϕ} ( t ; θ , ϕ ) = t [ \begin{matrix}sin ( θ ) cos ( ϕ ) \\ sin ( θ ) sin ( ϕ ) \\ cos ( θ )\end{matrix} ] \qquad Equation ( 31 )$$

Note that

$$‖ \frac{d \hat{ϕ}}{dt} ‖$$

is still 1, which leaves the integration along the t dimension unchanged from Equation (19). Additionally, dϕ is swapped for the surface area element of t² sin(θ)dθdϕ. Plugging in this transform, the following is found:

$${𝔼}_{P ( ϕ )} ( {P}_{1} ( {C}_{0}^{ρ} [ ϕ ] ) ) \leq 1 + - exp ( - P ( ϕ ) {\int }_{0}^{π} {\int }_{0}^{2 π} {\int }_{0}^{ρ} σ ( \hat{ϕ} ( t ; θ , ϕ ) ) {t}^{2} sin ( θ ) dtd θ d ϕ ) \qquad Equation ( 32 )$$

The triple integral in Equation (32) is the volume integral over a ball, and so this may be rewritten as

$${𝔼}_{P ( ϕ )} ( {P}_{1} ( {C}_{0}^{ρ} [ ϕ ] ) ) \leq 1 - exp ( - P ( ϕ ) {\int }_{𝕊} σ ( x ) dx ) \qquad Equation ( 33 )$$

It is recognized that P(ϕ)=1/| [symbol] ²|, where | [symbol] ²| is the surface area of the unit sphere. Combining this with Equation (28) results in the theorem.

With respect to integral evaluation, below is shown a closed-form method for computing the integral provided in Theorem 7. Here, it is assumed without loss of generality that the sphere is at the center of the coordinate system. Finally, the problem is simplified by integrating over the L_{∞}0 sphere instead of the L₂ sphere. This is denoted by [symbol] _{∞}, which corresponds to over-approximating the sphere with a cube. Then,

$${\int }_{𝕊} σ ( x ) dx \leq {\int }_{{𝕊}_{∞}} σ ( x ) dx = {\int }_{{𝕊}_{∞}} ( {\sum }_{n = 1}^{N} {w}_{n} {G}_{n} ( x ) ) dx = {\sum }_{n = 1}^{N} {w}_{n} {\int }_{{𝕊}_{∞}} exp ( - \frac{1}{2} {‖ ( x - {μ}_{n} ) ‖}_{{Σ}_{n}^{- 1}}^{2} ) dx \qquad Equation ( 34 )$$

Now, computing the integral for each Gaussian Gₙ is considered. Let

$${Σ}_{n} = {R}_{n} {Λ}_{n} {R}_{n}^{T}$$

define the Eigen decomposition of Σₙ. A coordinate system rotated by

$${R}_{n}^{T}$$

may be chosen to operate in. In this frame,

$${Σ}_{n}^{′} = {Λ}_{n} = diag \{ {λ}_{1} , {λ}_{2} , {λ}_{3} \} {μ}_{n}^{′} = {R}_{n}^{T} μ .$$

Since the covariance is now diagonal, the integration variables may be separated as shown below:

$${\int }_{{𝕊}_{∞}} {w}_{n} {G}_{n} ( x ) d x = {w}_{n} {\prod }_{i = 1}^{3} [ {\int }_{- ρ}^{ρ} exp ( - \frac{{( {x}_{i} - {μ}_{i}^{′} )}^{2}}{2 {λ}_{i}} ) {dx}_{i} ] = {w}_{n} {\prod }_{i = 1}^{3} [ \sqrt{\frac{{πλ}_{i}}{2}} ( erf ( \frac{ρ - {μ}_{i}}{\sqrt{2 {λ}_{i}}} ) - erf ( \frac{ρ + {μ}_{i}}{\sqrt{2 {λ}_{i}}} ) ) ] \qquad Equation ( 35 )$$

Above, erf denotes the error function, which is a well-known special function. While not computable in terms of elementary functions, erf can be approximated with exceptionally high accuracy. The implementation in the Nvidia™ CUDA (Compute Unified Device Architecture) API is calculated to the same or better precision as the trigonometric functions and exponentiation. Hence, erf evaluation can be considered to be correct and error arising from its use is not considered. See Section 16.1 of CUDA C Programming Guide, https://docs.nvidia.com/cuda/pdf/CUDA_C_Programming_Guide.pdf.

With respect to safe motion planning, the cost is minimized for as shown for Splanning-Opt:

$${min}_{k ∈ K} cost ( k ) \qquad Equation ( 36 )$$

$${q}_{j} ( {T}_{i} ; k ) ⊆ \begin{matrix}[ {q}_{j , lim}^{-} , {q}_{j , lim}^{+} ] & ∀ ( i , j ) ∈ {N}_{t} \times {N}_{q}\end{matrix} \qquad Equation ( 37 )$$

$${\dot{q}}_{j} ( {T}_{i} ; k ) ⊆ \begin{matrix}[ {\dot{q}}_{j , lim}^{-} , {\dot{q}}_{j , lim}^{+} ] & ∀ ( i , j ) ∈ {N}_{t} \times {N}_{q}\end{matrix} \qquad Equation ( 38 )$$

$$∀ ( i , j ) ∈ {N}_{t} \times {N}_{q} \qquad Equation ( 39 )$$

With reference to FIG. 4, there is shown an embodiment of a method 200 of estimating a collision probability between a robot and a radiance field within a three-dimensional environment. The method 200 is performed by the system 10 discussed above, at least in some embodiments. Although the steps of the method 200 are described as being performed in a particular order, it will be appreciated that the steps may be performed in any technically-feasible order, as will be made apparent to those skilled in the art in light of the discussion below.

The method 200 begins with step 210, wherein forward occupancy information is determined for a robot. The forward occupancy information indicates potential over-approximating volumes that are able to be occupied by a robot disposed at a starting position. In at least one embodiment, this step involves the use of polynomial zonotopes to overapproximate the robot's position, velocity, and forward occupancy over continuous time intervals. This is achieved by defining the forward occupancy of each link of the robot's arm, which maps the robot's configuration to the volume occupied by the arm in the workspace. The volumes occupied by the robot's links can be overapproximated by a collection of three-dimensional balls, following the assumption that each link volume is a subset of the tapered capsule formed by the convex hull of the balls overapproximating adjacent joints. The method 200 continues to step 220.

In step 220, an environment of the robot is modeled using a radiance field. A radiance field is a function that maps a point and viewing direction to colors and a volume density. In this context, the density function is used without considering the color components, focusing solely on estimating the density function from the radiance field. This density function is used for calculating the transmittance function, which determines the probability that a particle travels along a ray from one point to another without colliding with any obstacles. The method 200 continues to step 230.

In step 230, a probability of collision between the robot and an obstacle within the environment is computed based on the forward occupancy information and the radiance field. In at least one embodiment, this step involves calculating the probability of collision between the Spherical Forward Occupancy, which is an over-approximation of the robot's volume in the workspace, and the scene represented by the radiance field. In at least one embodiment, the collision probability is computed by integrating the density function over the volume of the forward occupancy and utilizing the transmittance function to find the likelihood of a particle colliding along a ray. This ensures that the probability of collision remains below a specified risk threshold, thus enforcing safety constraints during the robot's operation. The method 200 ends.

With reference to FIG. 5, there is shown an embodiment of a method 300 for real-time trajectory determination in a robotic system. The method 300 is performed by the system 10 discussed above, at least in some embodiments.

The method 300 begins with step 310, a trajectory of a robot is discretized into a sequence of discrete time instances. The continuous path that the robot might follow is segmented into distinct points that represent the robot's position at specific intervals of time. Each of these points corresponds to a particular moment, allowing for a frame-by-frame analysis of the robot's motion. This step is useful for ensuring that the robot's motion adheres to specified safety and operational constraints. The discretization is fundamentally about transforming the continuous trajectory of the robot into manageable segments that can be individually analyzed and optimized. The discretization starts with defining the entire time interval T over which the robot operates. This interval is segmented into discrete subintervals using Equation (15), where T is expressed as a set of times t that are calculated by incrementing the initial time t₀ by multiples of a time step At, within the range of [−1,1]. This segmentation effectively divides the robot's operation time into smaller, manageable intervals, each represented by a specific point in time t_{s,k}.

For each of these discrete time instances, the robot's position and velocity are constrained by Equations (12) and (13). These equations ensure that at every discrete point t_{s,k}, the position t_{s,k}, and velocity q(t_{s,k}) of the robot stay within predefined bounds. These bounds are useful for ensuring that the robot's motion remains safe and within operational limits, such as avoiding excessive speeds or straying outside of allowable areas. To handle the complexity of the robot's trajectory and its derivatives mathematically, Assumption 5, which is a lemma, introduces the use of polynomial zonotopes. These are mathematical tools that allow for an over-approximation of the robot's trajectory and velocity over the discrete intervals Tᵢ. By using polynomial zonotopes, the trajectory q(t; k) and its derivative \dot{q}(t; k) are approximated in a way that captures the behavior of the robot's motion while simplifying the computational requirements.

Assumption 6, which is a theorem, and Equation (18) further extend the discretization concept to the spatial domain by approximating the forward occupancy FOⱼ(q(Tᵢ; k)) of the robot. This is the volume of space that the robot occupies as it moves. This occupancy is approximated by TCⱼ(q(Tᵢ; k)), which is then simplified to a union of spheres S_{j,i,m}(q(Tᵢ; k)). This approximation is useful for assessing whether the robot's path might intersect with any obstacles or restricted areas within its environment, thus ensuring that the trajectory is not only feasible but also safe. The method 300 continues to step 320.

In step 320, an upper-bound for the probability of collision between the robot and a radiance field is computed at each of the discrete time instances using a Gaussian Splatting model that normalizes 3D Gaussians within the radiance field. In embodiments, the first part of this process involves normalizing the 3D Gaussians within the Gaussian Splatting model. Normalization is used to adjust the weights and scales of the Gaussian functions to balance their contributions to the density field accurately. This balanced representation allows for the precise calculation of collision probabilities.

Once the Gaussians are normalized, the next step is to cast rays from the robot's position into the environment at each discrete time instance, as determined by the robot's planned trajectory. These rays intersect the radiance field, which is represented by the normalized Gaussian Splatting model. The directions in which these rays are cast should preferably comprehensively cover the potential movement space of the robot, ensuring that all relevant collision scenarios are considered. For each ray cast into the radiance field, the probability of collision is calculated, and this calculation involves integrating the density along the path of the ray, at least in the present embodiment. The integration computes the likelihood of the ray colliding with the density field, which is represented by the sum of the normalized Gaussian functions. In the present embodiment, the specific formula used for this calculation is derived from Assumption 7, which is a theorem that provides a method for computing the collision probability for each ray based on the integrated density.

After calculating the collision probabilities for all rays at a given time instance, the next step is to determine an upper bound based on these probabilities. This is achieved, at least in the present embodiment, by aggregating the individual probabilities from all rays and applying Jensen's inequality, as detailed in Assumption 7. This inequality allows for determining a conservative estimate of the collision probability, ensuring that the computed upper bound represents a worst-case scenario, thereby enhancing safety. At least in the present embodiment, this step allows for adapting the trajectory in response to the dynamically modeled environment by the radiance field. The method 300 continues to step 330.

In step 330, real-time adjustments to the trajectory are performed based on the computed upper-bounds for collision probability. As discussed above, the computed upper-bound probabilities are then integrated into the motion planning algorithm as constraints. Each discrete time instance is associated with a collision probability that must not exceed a predefined safety threshold. If the computed upper-bound probability exceeds the predefined safety threshold at any time instance, the trajectory parameters are adjusted, and the probabilities are recomputed. This iterative refinement process continues until the collision probabilities for all time instances are within acceptable limits. The method 300 ends.

In this patent application, the term “Assumption” followed by a number (e.g., Assumption 1, Assumption 2, etc.) is used merely as a naming convention. It is important to note that some of these assumptions may be more accurately characterized as definitions, principles, lemmas, theorems, or criteria, as will be made apparent to those skilled in the art in light of the discussion herein. The use of the term “Assumption” is intended solely for organizational purposes and should not be construed as limiting or defining the nature or scope of the respective concepts, which may vary in their characteristics and roles within the context of this application.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A method of estimating a collision probability between a robot and a radiance field within a three-dimensional environment, the method comprising:
determining forward occupancy information indicating potential over-approximating volumes that are able to be occupied by a robot disposed at a starting position;
modeling an environment of the robot using a radiance field; and
computing a probability of collision between the robot and an obstacle within the environment based on the forward occupancy information and the radiance field.

2. The method of claim 1, wherein the probability of collision between the robot and an obstacle within the environment is determined using Gaussian Splatting.

3. The method of claim 2, further comprising a step of normalizing three-dimensional (3D) Gaussians in a Gaussian splatting model to ensure the correctness of the collision probabilities.

4. The method of claim 2, wherein the step of computing the probability of collision includes using the Gaussian Splatting by applying integration of normalized gaussian functions in a normalized gaussian splat for an efficient computation of a collision bound.

5. The method of claim 1, wherein the modeling step includes deriving a mathematical model that represents the radiance field as a continuous function over the environment, and wherein the radiance field is composed of a plurality of radiance elements contributing to the probability of collision.

6. The method of claim 1, wherein the forward occupancy information is spherical forward occupancy information modeled through representing one or more joints of the robot as spheres.

7. The method of claim 6, wherein the forward occupancy information indicates an over-approximated robot occupancy volume including a link volume extending between a first joint and a second joint.

8. The method of claim 7, wherein the link volume is over-approximated using a tapered capsule formed by a convex hull of a first sphere located at the first joint and a second sphere located at the second joint.

9. The method of claim 1, wherein the radiance field models the environment by mapping points and viewing directions to volume density, and wherein color is ignored as a part of the radiance field.

10. The method of claim 1, wherein the forward occupancy information is determined using polynomial zonotopes to overapproximate position and velocity trajectories of the robot over continuous time intervals.

11. The method of claim 1, wherein the step of determining forward occupancy information includes constructing a Spherical Forward Occupancy using a collection of three-dimensional spheres to overapproximate the volume occupied by the robot's arm in the workspace.

12. The method of claim 1, wherein the step of determining the probability of collision utilizes a transmittance function to compute the likelihood that a particle travels along a ray without collision, based on a density function computed from the radiance field.

13. The method of claim 1, wherein the step of computing the probability of collision between the robot and an obstacle represented within the radiance field involves computing an upper bound on the probability of collision using Markov's inequality.

14. The method of claim 1, wherein the computed probability of collision is used for trajectory optimization whereby a receding-horizon motion planning algorithm is used to select a feasible trajectory which does not exceed a user-specified collision probability threshold.

15. The method of claim 14, wherein the trajectory optimization includes real-time adjustments to a trajectory of the robot based on the forward occupancy information, and wherein the forward occupancy information is overapproximated by the Spherical Forward Occupancy which is computed using polynomial zonotopes.

16. The method of claim 1, wherein the radiance field is trained using simulated color and depth data to accurately represent the environment for collision probability estimation.

17. A method for real-time trajectory determination in a robotic system, comprising:
discretizing a trajectory of a robot into a sequence of trajectory segments over time subintervals;
computing an upper-bound for a probability of collision between the robot and a radiance field at each of the time subintervals using a Gaussian Splatting model that normalizes 3D Gaussians within the radiance field; and
performing real-time adjustments to the trajectory based on the computed upper-bounds for collision probability.

18. The method of claim 17, wherein the computing step includes the use of a probabilistic model to account for uncertainties in the position and shape of the radiance field.

19. The method of claim 17, further comprising aggregating the computed upper-bounds to estimate an overall collision probability for the entire trajectory.

20. The method of claim 19, wherein the aggregating step uses a risk assessment algorithm to prioritize trajectory segments based on their associated collision probabilities.

21. The method of claim 17, wherein the Gaussian Splatting model is derived directly from the rendering equation.

22. The method of claim 17, wherein the robot includes a manipulator operating within a dynamic environment with unpredictable changes.

23. The method of claim 17, wherein the real-time adjustments to the trajectory include avoidance maneuvers to minimize the collision probability.

24. The method of claim 17, wherein the real-time adjustments are computed using a receding-horizon motion planning algorithm.

25. A robotic collision avoidance system comprising a robot, at least one environment sensor, and a processing subsystem having one or more processors and memory storing computer instructions, wherein the robotic collision avoidance system carries out the method of claim 1 by execution of the computer instructions by the one or more processors.

26. The robotic collision avoidance system of claim 25, wherein the step of modeling the environment comprises modeling the environment using data from the at least one environment sensor.

27. A non-transitory, computer-readable medium having stored thereon computer instructions that, when executed by one or more processors, carry out the method of claim 1 using data received from at least one environment sensor.

28. A robotic collision avoidance system comprising a robot, at least one environment sensor, and a processing subsystem having one or more processors and memory storing computer instructions, wherein the robotic collision avoidance system carries out the method of claim 17 by execution of the computer instructions by the one or more processors.

29. The robotic collision avoidance system of claim 28, wherein the radiance field is generated using data from the at least one environment sensor.

30. A non-transitory, computer-readable medium having stored thereon computer instructions that, when executed by one or more processors, carry out the method of claim 17 using data received from at least one environment sensor.
